(19) United States
(12) Patent Application Publication
(10) Pub. No.: US 2020/0051034 A1
(43) Pub. Date: Feb. 13, 2020

(54) System and Method for Directing Third Party Deposits Into an Employer Sponsored Retirement Account

(71) Applicants: Daniil Tseytlonok, Alameda, CA (US); Yevgen Prudchyenko, Alameda, CA (US)

(72) Inventors: Daniil Tseytlonok, Alameda, CA (US); Yevgen Prudchyenko, Alameda, CA (US)

(21) Appl. No.: 16/536,446

(22) Filed: Aug. 9, 2019

Related U.S. Application Data
(60) Provisional application No. 62/716,854, filed on Aug. 9, 2018.

(51) Int. Cl. G06Q 10/10; G06Q 40/00

(52) U.S. Cl. CPC G06Q 10/1057; G06Q 40/125

(57) ABSTRACT

A system and method for directing third party deposits into an employer sponsored retirement account associated with an employee includes an online retirement fund entity contacting a payroll department of the employer and instructing them to deduct an amount from the respective employee's paycheck and to deposit the retirement contribution into the employee's retirement account in a respective retirement account, thus reducing the employee's gross compensation before being taxed. The deducted amount is contributed to the retirement account associated with the employee. Then, the online retirement fund entity deposits an amount of money exactly equal to the amount deducted from the employee's paycheck into a bank account associated with the employee so as to replace the amount deducted from the employee's paycheck. In the end, the employee member's retirement account is larger as a result of retirement fund contributions and his overall taxation has been reduced.

### REFERENCE TO RELATED APPLICATIONS

This application claims the benefit of provisional patent application U.S. Ser. No. 62/716,854 filed Aug. 9, 2018 titled Platform for Multiple Sources Third Party Deposits into Employees Sponsored Retirement Account which is incorporated in its entirety herein by reference.

### BACKGROUND OF THE INVENTION

This invention relates to online systems for advertising, buying, and selling of goods and services and, more particularly, to an online system that instructs an employer to make a payroll deduction from an associated employee's paycheck and respective contribution to an employee's employer sponsored retirement account in an amount equal to sponsored retirement cards purchased by the employee, retirement cards purchased on behalf of the employee, and third party deposits made on behalf of the employee. Then, the contributed amount is deposited into a bank account of the employee in the amount deducted from his paycheck. The employee is a member of the online retirement deposits program for contribution to the employee's own retirement account in a tax saving methodology.

Third parties, whether online buy-sell rewards systems, relatives, or others desiring to give a gift to another person, often do not have a good way to transfer such a gift as retirement funds without adding to the tax burden of the “giftee.” One way to do this is to contribute to the other person's retirement account. Unfortunately, there is currently no way for the gift giver to contribute directly to a friend's employer sponsored retirement account. For instance, a 401(k) account is largely outside the control of an employee other than to specify an amount to be deducted from each paycheck and contributed to the retirement account.

Therefore, it would be desirable to have system or other permitted third party that instructs an employer to make a payroll deduction and contribution to an employee's employer sponsored retirement account in an amount equal to retirement funds attributed to the employee (in this case from the sale of retirement fund cards) and which then deposits the amount contributed into a bank account of the employee so as to replace the amount deducted and contributed to the retirement account.

### SUMMARY OF THE INVENTION

A system and method for directing third party deposits into an employer sponsored retirement account associated with an employee according to the present invention includes an employer receiving a request from an employee to participate in a retirement deposit program and assigning an identification number associated with the employee. An online retirement fund entity, on behalf or in cooperation with the employee, contacts a payroll department of the employer and instructs to deduct an amount (i.e. a retirement contribution) from the respective employee's paycheck and to deposit the retirement contribution into the employee's retirement account in an employer sponsored retirement account, thus reducing the employee's gross compensation. It is this reduced compensation that is taxed. The deducted amount is then contributed to the employer sponsored retirement account associated with the employee. Then, the online retirement fund entity deposits an amount of money exactly equal to the amount deducted from the employee's paycheck (i.e. the retirement contribution) into a bank account associated with the employee so as to replace the amount deducted from the employee's paycheck. In the end, the employee member's retirement account is larger as a result of retirement fund deposits (such as from the sale of retirement cards) contributed to his retirement account and his overall taxation has been reduced.

Therefore, a general object of this invention is to provide a system and method providing a third party system to contribute to an employer sponsored retirement account.

A further object of this invention is to provide a system and method in which a retirement fund entity is authorized to contact, on behalf of a member/employee, a payroll entity associated with an employer and instruct the same to deduct a contribution amount from the employee's paycheck equal to the contributed amount and then to contribute the deducted amount to a retirement account associated with the employee.

A still further object of this invention is to provide a system and method that contributes an amount to a member's bank account or address equal to the amount by which the member/employee's paycheck was reduced in order that a contribution to the member/employee's employer sponsored retirement account was made.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram of a system and method enabling third parties to deposit funds into an employer sponsored retirement account of an employee according to a preferred embodiment of the present invention, illustrated to show the system and flow of data; and

FIG. 2 is a block diagram of the system and method as in FIG. 1, illustrated to show a flow of financial funding of the member/employee and retirement contribution.

### DESCRIPTION OF THE PREFERRED EMBODIMENT

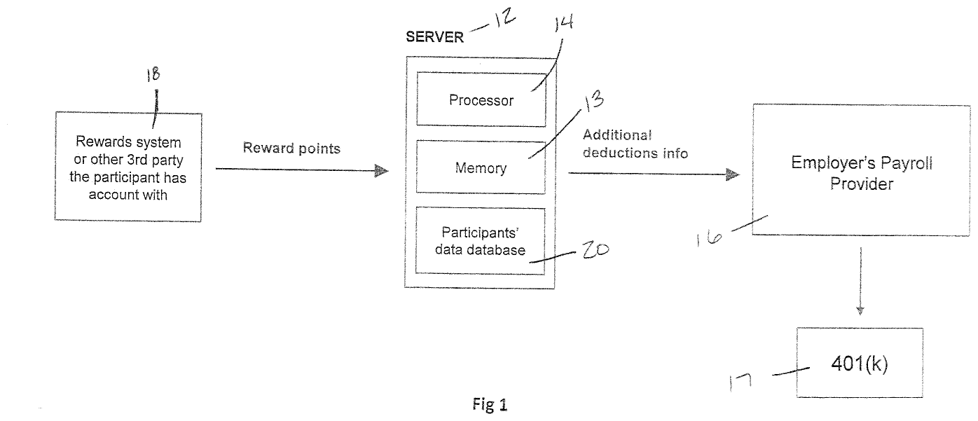

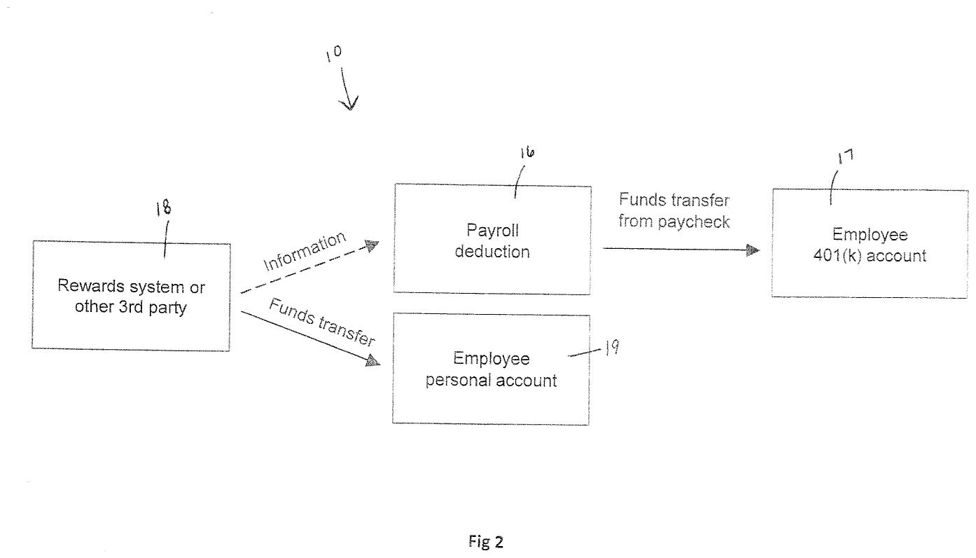

An online system and method for directing third party contributions into an employer sponsored retirement account associated with an employee will now be described in detail with reference to FIGS. 1 to 2 of the accompanying drawings. More particularly, the system and method 10 that enables third parties to deposit funds into an employer sponsored retirement account of an employee includes at least one computer 12 such as a network server, operably connected to a wide area network such as the internet and accessible by remote computers in a traditional manner (FIG. 1). It will be understood that the system 10 may be administered by an online “platform” which may also be referred to as the “retirement fund entity” as described herein and recited in the claims. Employers may offer membership in the retirement fund system 10 as a benefit to its employees.

Specifically, the system 10 is designed to be used by its members to purchase retirement cards or third parties to purchase retirement cards on behalf of the member and, as a result, to facilitate contribution of the purchase amount to an employer sponsored retirement account associated with an employee—who may be referred to as the member-employee (i.e. a member of the retirement program and an employee of the employer offering the retirement program as a benefit, according to the details to be described below. In one important aspect, a retirement fund is associated with the member-employee and which represents the amount of funds to be deposited into the employee's respective retirement account. That amount to be deposited is referred to as the “retirement fund deposits” associated with the employee.

More particularly, the retirement funds entity 18, will communicate with a member's employer (or the employer's payroll entity) and facilitate retirement contributions to members, and as will be described later. The system 10, administered by a retirement fund entity 18) may be configured and managed by an administrator having security access to all aspects of the computer, memory, including data and programming. The present invention, however, includes more than merely a computer executing programming steps as will be disclosed below.

The computer 12 may include a non-volatile memory 13 configured to store a plurality of programming instructions and includes a processor 14 configured to selectively execute the program instructions in a manner that operates the system 10 as will be described below. The memory 13 may also be structured so as to store a plurality of data structures such as one or more databases and data that may be stored and manipulated by operation of the programming instructions.

Data structures stored in the memory 13 may include, but are not limited to the databases described below. The system 10 may include a member database 20 that may include a plurality of member records associated with a member or participant in the retirement funds program (FIG. 2). Each record may include, but not be limited to, login data, contact or address data, reward data, and other data.

It is understood that an employee's employer may offer an employer sponsored retirement program to its employees. The employee may be required to opt in to this program and may be assigned an identification number, i.e. an account number identifying the employee's specific retirement account. Further, the employee must also be a “member” of the retirement funding entity 18 that offers to apply its member retirement funds to the retirement accounts of its member. The member of the retirement funds program who is also an employee of a participating employer may be referred to herein as a member employee and may be assigned an identification number or other identifying code.

The processor 14, executing respective programming instructions, is capable of calculating a retirement contribution amount attributable to a member (i.e. the amount accumulated in the retirement fund deposits generated from sales of retirement cards to the member-employee, purchased on behalf of the member-employee by third parties, or amounts otherwise donated on behalf of member-employee), communicating with the member's employer and said employer's payroll department, and instructing the payroll department to deduct a calculated retirement deposit amount and to contribute that amount to the employee's retirement account. More particularly, the processor 14, under program control communicates, such as automatically via the internet, with a payroll provider 16 or department associated with the employer and associated with the employee who is a member of a participating program 18. Upon establishing said communication, the processor 14 instructs the member employee's payroll department to deduct the amount of the retirement contribution, or an amount agreed upon thereby, from the gross wages of the employee's next paycheck prior to its taxation. The processor 14 further instructs the payroll provider 16 to contribute the deducted amount as a retirement contribution to the retirement account 17 associated with the employee and that is associated with the employer sponsored retirement program offered by the employer.

It is understood that employer sponsored retirement program may be a 401(k) account or other similar program organized by the Internal Revenue Service. The particular program as well as sign-up information may be required to be entered in a setup routine (not shown). Similarly, an employee member may be required to request his employer to become involved in the program described above. In fact, the payroll provider 16 may choose to integrate portions of the software described above with its own payroll software to carry out the deduction and contribution functions.

One such retirement fund agency is the EvoShare retirement fund. Specifically, EvoShare may offer to sell retirement fund cards to respective members or to third parties on behalf of a respective member. In addition, EvoShare retirement cards may be available for sale by other third party reward programs. In other words, a cash-back or travel miles program makes several products available for sale or redemption by their members, respectively, and EvoShare cards may be offered for sale in that manner also. In any case, purchase of a retirement fund card is associated with an employee such that the employee's employer may be contacted to make an appropriate paycheck deduction and contribution to the respective employee's retirement account as described herein.

Now is presented a “real world” example of how the system and method described above is implemented and executed in a payroll environment to the employee's advantage:
1. A gifter, or an employee, buys an EvoShare Retirement Card for a desired amount of contribution and pays a fee associated with it.
2. EvoShare deposits an amount equal to the face value of the EvoShare Retirement Card into the participating employee's checking account and notifies, on behalf of the employee, either the employer or a respective payroll provider to make an additional deduction from the employee's paycheck. The deduction is always equal to the amount deposited into the employee's checking account.
3. Thus, there is no direct contribution by the gifter to the employee's retirement account. The contributions always come from the employee's paycheck. However, the employee pays fewer taxes.

Here is an example, where Joe (the employee) makes $8,000 per month with no matching to a 401(k) from the employer.

### Without EvoShare

| | |
|---|---|
| Gross Income | $8,000 |
| Contribution to 401k | $160 |
| (2%) | |
| Adjusted Gross | $7,840 |
| Taxes (25% rate) | $1,960 |
| Take-home pay | $5,880 |
| Total Cash | $5,880 |
| Total savings | $160 |

With EvoShare. Joe Makes Purchases at Participating Stores and he has Earned $200 Cash Back.

| | |
|---|---|
| Gross Income | $8,000 |
| Contribution to 401 k (2%) | $160 |
| Contribution because of | $200 |
| EvoShare to 401 k | |
| Adjusted Gross | $7,640 |
| Taxes (25% rate) | $1,910 |
| Take-home pay | $5,730 |
| Cash back to checking account | $200 (non-taxable) |
| Total Cash | $5,930 |
| Total savings | $360 |

Conclusions: With EvoShare, Joe pays fewer taxes, makes more savings and gets more cash.

In another aspect, the retirement fund entity includes data structures and programming that keeps track of all tax savings associated with a member-employee that result from the employer's cafeteria benefits plan or other reimbursement plan. Such tax savings may be communicated regularly to the participating employer or the employer's payroll entity. These reported savings may be treated as retirement fund deposits and result in further contributions to the retirement account associated with the employee as described above.

It is understood that while certain forms of this invention have been illustrated and described, it is not limited thereto except insofar as such limitations are included in the following claims and allowable functional equivalents thereof.

1. A system for directing third party deposits into an employer sponsored retirement account, said system comprising:
a computer server having a processor connected to the wide area network and that provides a user interface to the network;
a non-volatile memory in said computer server in data communication with said processor and configured to store programming and data structures;
programming in said memory that, when executed by said processor, causes said processor to:
determine a retirement contribution amount equal to at least a portion of retirement fund deposits associated with a member of a retirement fund entity and an employee of a participating employer;
wherein said retirement fund deposits include retirement card sales and third party deposits associated with the member;
transmit an instruction to a payroll entity associated with the member's employer, on the member's behalf, to deduct an amount equal to said retirement contribution amount from a paycheck associated with said member and to make a contribution to a retirement account associated with the member and with the employer sponsored retirement account in an amount equal to said deducted amount;
direct a monetary payment in an amount equal to said retirement contribution amount to a bank account or address associated with said member.

2. The system as in claim 1, wherein said deducted amount is deducted prior to taxation of a gross compensation amount of said paycheck.

3. The system as in claim 1, wherein said employer sponsored retirement account is a 401(k) account.

4. The system as in claim 1, wherein the employer sponsored retirement account associated with the employee allows limited control by plan participants and is not subject to receiving deposits directly from third parties.

5. The system as in claim 1, further comprising a member database stored in said memory and in data communication with said processor and having a unique member identification number, member address, and member banking data associated with each member of the retirement fund entity.

6. The system as in claim 1, wherein said programming, when executed by said processor, causes said processor to repeat, according to a predetermined time regularity, the steps of determining a retirement contribution amount, transmitting an instruction to the payroll entity, and directing a monetary payment.

7. The system as in claim 1, wherein said programming is integrated into software operated by the payroll entity associated with the employer and the member.

8. The system as in claim 1, wherein said retirement fund entity is the EvoShare Retirement Card fund and is associated with the member making said request to make a contribution to the employer sponsored retirement account associated with the employee.

9. The system as in claim 1, wherein the retirement fund entity is an online system that provides retirement funds as a result of spending.

10. The system as in claim 9, wherein the retirement fund entity is EvoShare™.

11. A method for directing third party retirement fund deposits into an employer sponsored retirement account associated with an employee, said method comprising:
an employer receiving a request from an employee to participate in an online retirement deposit program and assigning an identification number associated with the employee;
a retirement fund entity determining a retirement contribution amount equal to a portion of retirement fund deposits associated with the employee;
wherein said retirement fund deposits include retirement card sales and third party deposits attributed to the employee;
said retirement fund entity instructing, via the internet, a payroll entity associated with the employee and the employee's employer to make a contribution equal to said retirement contribution amount to the employer sponsored retirement account associated with the employee; and
directing the payroll entity associated with the employee and the employer sponsored retirement account to deduct an amount equal to said retirement contribution amount from a paycheck associated with the employee and to deposit said deducted amount into the employer sponsored retirement account associated with the employee.

12. The method as in claim 11, further comprising directing a monetary payment equal to said deducted amount to a bank account or mailing address associated with the employee, whereby to match said deducted amount from the paycheck of the employee.

13. The method as in claim 11, wherein said deducted amount is deducted prior to taxation of a gross compensation amount of said paycheck.

14. The method as in claim 11, wherein said employer sponsored retirement account is a 401(k) account.

15. The method as in claim 14, wherein said employer sponsored retirement account associated with the employee allows limited control by plan participants and is not subject to receiving deposits directly from third parties.

16. The method as in claim 11, further comprising repeating the steps of receiving said retirement contribution amount, deducting an amount equal to said retirement contribution amount, and depositing said deducted amount into the employer sponsored retirement account is repeated on a predetermined regular basis.

17. The method as in claim 11, wherein said steps of receiving said contribution amount, deducting an amount equal to said deposit of funds, and depositing said deducted amount into the employer sponsored retirement account are integrated into software operated by the payroll entity associated with the employer and the employee.

18. The method as in claim 11, wherein said retirement fund entity is the EvoShare Retirement Card fund and is associated with the employee making said request to make a contribution to the employer sponsored retirement account associated with the employee.

19. The method as in claim 11, wherein the retirement fund entity is an online buy-sells system that provides retirement cards for sale.

20. The method as in claim 19, wherein the retirement fund entity is EvoShare™.
